(19) United States
(12) Patent Application Publication
(10) Pub. No.: US 2016/0258610 A1
(43) Pub. Date: Sep. 8, 2016

(54) ILLUMINATING DEVICE

(71) Applicant: Kabushiki Kaisha Toshiba, Minato-ku (JP)

(72) Inventors: Kakeru YAMAGUCHI, Yokohama (JP); Hideo NISHIUCHI, Yokohama (JP)

(73) Assignee: Kabushiki Kaisha Toshiba, Minato-ku (JP)

(21) Appl. No.: 15/040,575

(22) Filed: Feb. 10, 2016

(30) Foreign Application Priority Data
Mar. 5, 2015 (JP) 2015-043479

(51) Int. Cl. F21V 29/505; F21V 7/04; F21V 23/02; F21V 29/70

(52) U.S. Cl. CPC F21V 29/505; F21V 29/70; F21V 7/04; F21V 23/02; F21Y 2101/02

(57) ABSTRACT

According to one embodiment, an illuminating device includes a light source, a reflector, and a heat transfer member. The light source includes a light emitting element. The reflector is provided to surround the light source. The heat transfer member is provided outside the reflector and thermally bonded to the reflector.

### CROSS-REFERENCE TO RELATED APPLICATIONS

This application is based upon and claims the benefit of priority from Japanese Patent Application No. 2015-043479, filed on Mar. 5, 2015; the entire contents of which are incorporated herein by reference.

### FIELD

Embodiments described herein relate generally to an illuminating device.

### BACKGROUND

An illuminating device such as a projector using a light emitting diode (LED) as a light source has been in practical use. The illuminating device using the light emitting diode as the light source has a long life and is able to reduce power consumption. However, in the illuminating device like this, improvement of heat dissipation generated in the light source or the like has been requested.

### BRIEF DESCRIPTION OF THE DRAWINGS

FIG. 1 is a schematic perspective view of an illuminating device according to an embodiment;

FIG. 2A and FIG. 2B are schematic views of the illuminating device according to the embodiment;

FIG. 3 shows inside the illuminating device according to the embodiment;

FIG. 4 shows a portion of the illuminating device according to the embodiment;

FIG. 5 shows a portion of the illuminating device according to the embodiment;

FIG. 6 shows another form of the portion of the illuminating device according to the embodiment;

FIG. 7 shows another form of the portion of the illuminating device according to the embodiment;

FIG. 8 shows another form of the portion of the illuminating device according to the embodiment;

FIG. 9 shows another form of the portion of the illuminating device according to the embodiment;

FIG. 10A to FIG. 10C shows heat dissipation of the illuminating device.

### DETAILED DESCRIPTION

According to one embodiment, an illuminating device includes a light source, a reflector, and a heat transfer member. The light source includes a light emitting element. The reflector is provided to surround the light source. The heat transfer member is provided outside the reflector and thermally bonded to the reflector.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

In the specification, “bond thermally” means that heat is transferred by one of thermal conduction, convection, and radiation (emission) between object components. The thermal bond is not limited to the state in which the object components contact each other, but another component may be intervened between the object components. In one of contact state ans non-contact state between the object components, the thermal bond is not necessarily to be made over the whole region of the object components, and I sonly necessary to be made in at least a portion.

In the specification, “provided on” includes the case of being provided to contact directly and further includes the case of being provided with another component inserted therebetween. “Being provided to oppose” includes the case the case of being provided to contact directly above or below and further includes the case of being provided with another component inserted therebetween.

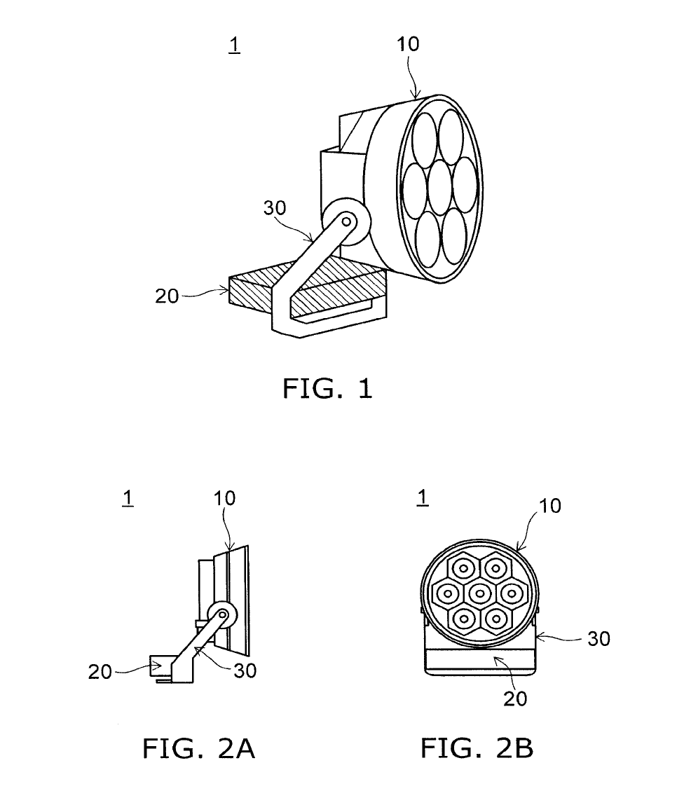

FIG. 1 is a schematic perspective view of an illuminating device according to an embodiment.

FIG. 2A and FIG. 2B are schematic views of the illuminating device according to the embodiment.

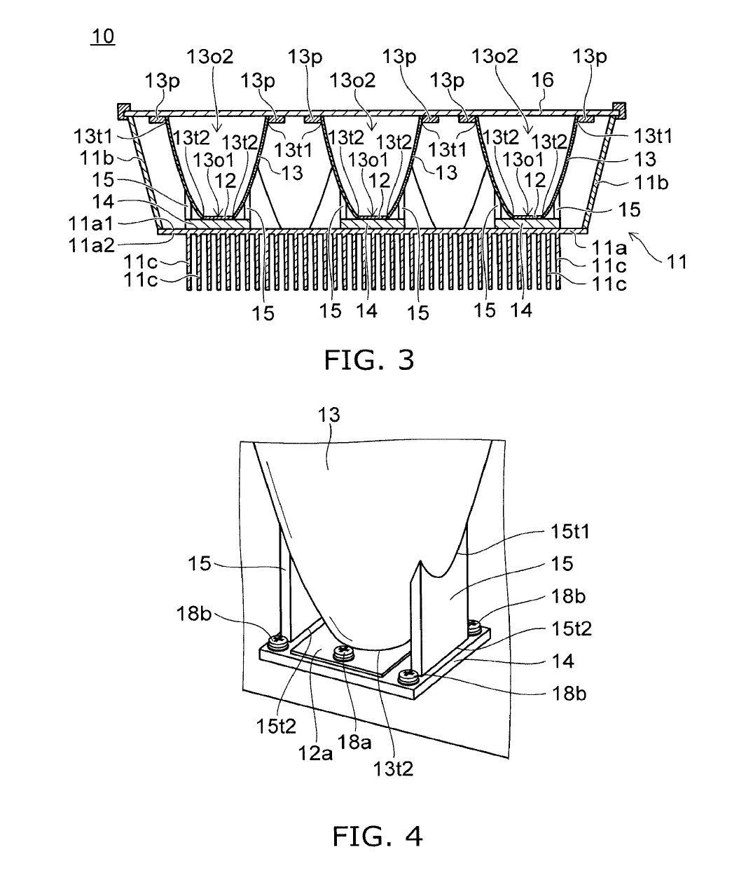

FIG. 3 shows inside the illuminating device according to the embodiment.

FIG. 4 shows a portion of the illuminating device according to the embodiment.

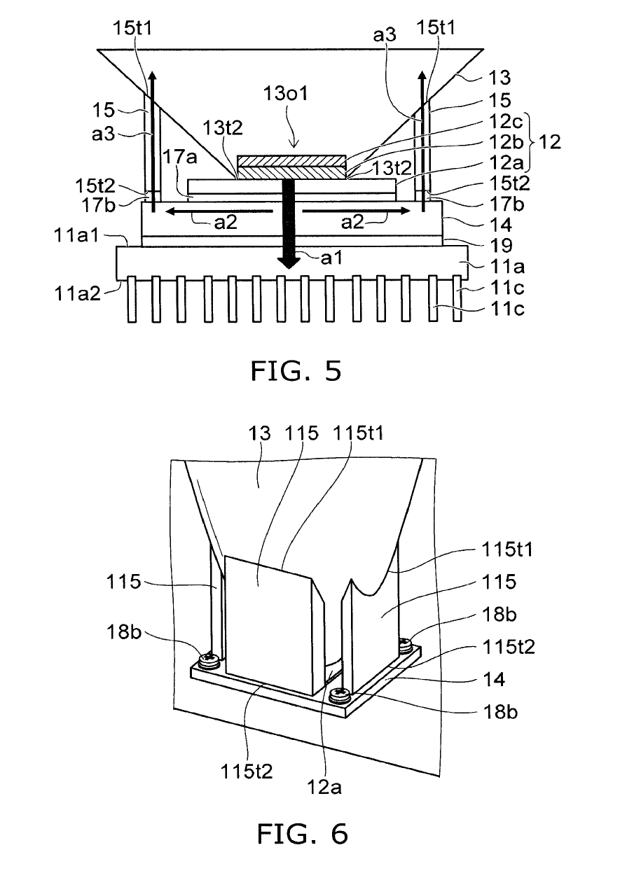

FIG. 5 shows a portion of the illuminating device according to the embodiment.

FIG. 2A is a side view of the illuminating device 1. FIG. 2B is a front view of the illuminating device 1 viewed from the light source side. FIG. 3 shows inside of a main body unit viewed from a side surface of the illuminating device 1. FIG. 4 is an enlarged view of a member disposed in the proximity of the light source. FIG. 5 is a cross-sectional view of FIG. 4. Arrows a1 to a3 in FIG. 5 show a heat transfer direction.

As shown in FIG. 1 and FIG. 2, the illuminating device 1 is provided with a main body unit 10, a power supply unit 20, and a mounting unit 30. For example, the illuminating device 1 of the embodiment is used for the projector or the like for illuminating a door plate and for illuminating for direction a building. The multiple illuminating devices 1 are disposed and may be used for an illuminating equipment of a ball game field or the like.

As shown in FIG. 3 to FIG. 5, the main body unit 10 includes a chassis 11, a light source 12, a reflector 13 (reflector), a heat dissipation member 14, a heat transfer member 15, and a cover body 16. A direction from the light source 12 toward the cover body 16 is an illuminating direction of light.

The chassis 11, for example, can be formed from material excellent in heat dissipation such as aluminum or aluminum die-cast. The chassis 11 includes a bottom face portion 11a, a side wall portion 11b, and multiple heat dissipation fins 11c.

The bottom face portion 11a is, for example, formed of a nearly circular flat plate including a metal. The bottom face portion 11a has a first surface 11a1 and a second surface 11a2. The second surface 11a2 is a surface opposite to the first surface 11a1. The bottom face portion 11a is provided with wiring holes (not shown) for electrically connecting the power supply unit 20 to the light source 12.

The side wall portion 11b is provided in the light illuminating direction from a periphery of the first surface 11a1 of the bottom face portion 11a. The side wall portion 11b has, for example, a continuous frame shape along the periphery of the first surface 11a1 of the bottom face portion 11a.

The light source 12, the reflector 13, the heat dissipation member 14, and the heat transfer member 15 are provided in a region surrounded by the bottom face portion 11a and the side wall portion 11b.

The multiple heat dissipation fins 11c extend in a direction opposite to the light illumination direction from the second surface 11a2 of the bottom face portion 11a. The multiple heat dissipation fins 11c are, for example, provided to protrude from the second surface 11a2. As shown the arrow a1 of FIG. 5, a portion of heat generated in the light source 12 is transferred to the multiple heat dissipation fins 11c and is emitted to the outside from the multiple heat dissipation fins 11c.

The light source 12 is provided on the first surface 11a1 of the bottom face portion 11a. The light source 12 includes a substrate 12a, a light emitting element 12b, and a wavelength conversion unit 12c. The light source 12 may include a lens for light distribution provided on the wavelength conversion unit 12c.

The number of the light source 12 is arbitrary, and can be decided in response to use of the illuminating device 1 and a size of the light emitting element 12b or the like. In the embodiment, the number of the light source 12 is 7, and in the respective light sources 12, the light emitting element 12b and the wavelength conversion unit 12c are provided on the substrate 12a.

COB (Chip On Board) method directly mounting the light emitting element 12b on the substrate 12a can be used for the light source 12. The light source 12 may mount multiple SMD (Surface Mount Device) type light source parts on the substrate 12a as well.

The substrate 12a is insulative and has low thermal expansion, and further can be formed of materials excellent in heat dissipation and thermal resistance. The substrate 12a can be formed of, for example, base material of ceramics, metal, composite ceramics of ceramics and metal (for example, copper alloy or the like), and glass epoxy or the like. Ceramics exemplifies, for example, aluminum oxide (Al₂O₃), aluminum nitride (AlN), silicon nitride (SiN), steatite (MgO.SiO₂), zircon (ZrSiO₄) or the like. However, the material of the substrate 12a is not limited to exemplified materials.

The substrate 12a is provided, for example, on the heat dissipation member 14 via a bonding portion 17a. The bonding portion 17a bonding the substrate 12a to a portion of the heat dissipation member 14 is, for example, a bonding agent including a metal material. The bonding portion 17a is a metal bonding agent being heat conductive, for example, an alloy solder of lead (Pb) and tin (Sn). The bonding portion 17a may include a lead free solder or the like containing silver (Ag) and copper (Cu).

The substrate 12a is mounted on the heat dissipation member 14, for example, by fixing the end portion by a screw 18a.

The light emitting element 12b can be, for example, a so called spontaneous light emitting element such as a light emitting diode, an organic light emitting diode, a laser diode or the like. The light emitting element 12b is provided on the substrate 12a. The light emitting element 12b can include an element mounted (flip chip mounting) via a bump (protrusion) provided on a surface on a connection side, and an element mounted by a wire bonding method.

The number of the light emitting elements 12b provided on the substrate 12a is arbitrary, and can be decided in response to use or the like of the illuminating device 1. For example, in the case of using the COB method for the light source 12, the multiple light emitting elements 12b mounted on the substrate 12a can be electrically connected in series by the wire bonding method.

The wavelength conversion unit 12c is provided on the light emitting element 12b. The wavelength conversion unit 12c is, for example, provided so as to cover the light emitting element 12b. The wavelength conversion unit 12c includes a fluorescent material excited by a primary light emitted from the light emitting element 12b.

The wavelength conversion unit 12c can be, for example, a unit where particle fluorescent material is dispersed into light transmissive organic and inorganic materials. For example, the wavelength conversion unit 12c can be a unit where particle fluorescent material is dispersed into a resin including silicone as a main component.

The fluorescent material included in the wavelength conversion unit 12c can include, for example, at least one type od elements selected from the group of silicon (Si), aluminum (Al), titanium (Ti), germanium (Ge), phosphorous (P), boron (B), yttrium (Y), an alkaline earth element, a sulfide element, a rare-earth element, nitride element.

For example, when the light emitting element 12b is a blue light emitting diode, and the fluorescent material included in the fluorescent material layer emits yellow fluorescence, yellow fluorescence is radiated from the fluorescent material. The blue light and the yellow light are mixed, and thus white light is emitted from the light source 12. The fluorescent material is not limited to a fluorescent material emitting yellow, and can be appropriately changed so as to enable to obtain a desired luminescence color depending on the use of the illuminating device 1.

The reflector 13 is provided to surround the light source 12. When the seven light sources 12 are provided like the embodiment, the seven reflectors 13 are provided so as to surround the respective light sources 12. For example, the shape of the reflector 13 is annular when projected to a flat surface perpendicular to the direction from the light source 12 toward the cover body 16, and is parabolic to gradually increase from the light source 12 side to the cover body 16 side. The shape of the reflector 13 is, for example, tubular such as cylindrical, both ends of the reflector being opened, and the light source 12 is provided in an opening 13o1 of the reflector 13.

The reflector 13 is, for example, specularly reflective. For example, a sheet of silver (Ag) or aluminum (Al) or the like is provided on an inner wall surface (reflection surface) of the reflector 13, and thereby the reflector 13 is specularly reflective. If the reflector 13 is specularly reflective, the light emitted from the light source 12 is reflected specularly at the inner wall surface. The reflector 13 may be diffusively reflective. For example, a fine unevenness structure or white diffusive reflection paint such as magnesium oxide or the like is provided on the inner wall surface if the reflector 13, and thereby the reflector 13 is diffusively reflective. If the reflector 13 is diffusively reflective, the light emitted from the light source 12 is diffusively reflected on the inner wall surface.

A protrusion 13p is provided on an end portion 13t1 on the cover body 16 side of the reflector 13. As described previously, when the shape of the reflector 13 is annular, the protrusion 13p is provided along a circumference in a direction nearly perpendicular to the direction from the light source 12 toward the cover body 16. For example, the protrusion 13p of the reflector 13 is connected to at least one of the bottom face portion 11a and the side wall portion 11b of the chassis 11 by a fixing member (not shown) or the like, and thereby the reflector 13 is housed in the chassis and fixed.

An end portion 13t2 on the light source 12 side of the reflector 13 does not contact directly the substrate 12a of the light source 12. For example, a gap is provided between the end portion 13t2 and the substrate 12a. This allows the light source 12 to be insulated from the reflector 13. A sheet of silicon (Si) or the like may be provided between the end portion 13t2 and the substrate 12a. When the sheet is provided between the end portion 13t2 and the substrate 12a, the light source can be insulated from the reflector 13 and light leakage through the gap between the end portion 13t2 and the substrate 12a can be suppressed.

If the substrate 12a is caused not to contact directly the end portion 13t2, in the case where the reflector 13 receives oscillation and impact from the external, the oscillation and the impact are not easy to be transferred from the reflector 13 to the light source 12. This allows the light source 12 to be protected from the oscillation and the impact.

The heat dissipation member 14 is provided between the bottom face portion 11a of the chassis 11 and the substrate 12a of the light source 12. The heat dissipation member 14 is, for example, rectangular. The heat dissipation member 14 is, for example, a heat spreader, and is placed between the light source 12 being a heating element and the heaty dissipation fin 11c being a radiator, and thereby efficiency of radiator of the heat dissipation fin 11c can be increased.

The heat dissipation member 14 can be formed of a material having a high thermal conductivity. The heat dissipation member 14 can be formed of, for example, a pure metal such as aluminum (Al), copper (Cu) and an alloy. However, it is not limited to these, and can be formed of an inorganic material having high thermal conductivity such as aluminum nitride (AlN), aluminum oxide (Al₂O₃), steatite (MgO.SiO₂), and an organic material such as a high thermal conductivity resin as well.

The heat dissipation member 14 is provided, for example, on the bottom face portion 11a (first surface 11a1) of the chassis 11 via a bonding portion 19. The bonding portion 19 bonding the heat dissipation unit 14 and the bottom face portion 11a is, for example, a bonding agent including a metal material. The bonding portion 19 is, for example, grease such as silicone or the like including silver and copper.

The heat dissipation member 14 is mounted on the bottom face portion 11a by fixing the end portion by a screw 18b.

The cover body 16 is mounted on the chassis. For example, the cover body 16 is mounted on the chassis 11 by fitting an outer edge of the cover body 16 to a concave end portion of the side wall portion 11b. The main body 10 functions as an illumination device (for example, a narrow angle projector, an intermediate angle projector, a broad angle projector) capable of radiating in response to the desired light distribution angle by mounting the cover body 16 on the chassis 11.

The cover body 16 covers the opening 13o2 of the reflector 13. The opening 13o2 of the reflector 13 is covered with the cover body 16, and thereby the light source 12 provided in the opening 13o1 is protected from oscillation and impact from the external.

The cover body 16 may be bonded thermally to the reflector 13. For example, the cover body 16 can contact the end portion 13t1 of the reflector 13. The cover body 16 is caused to contact the end portion 13t1, and thereby the heat transferred to the reflector 13 is transferred to the cover body 16 by thermal conduction, and is emitted externally from the cover body 16. The cover body 16 may contact both of the end portion 13t1 and the protrusion 13p of the reflector 13. Since the contact area between the reflector 13 and the cover body 16 can be increased by causing the cover body 16 to contact both of the end portion 13t1 and the protrusion 13p, the heat becomes easy to be emitted from the cover body 16.

The cover body 16 is formed of, for example, light transmissive glass or the like. For example, the cover body 16 is a glass plate. Any material which can protect the light source 12 from the external oscillation and impact, and emit the heat from the reflector 13 can be used for the cover body 16.

The power supply unit 20 supplies power to the light source 12. For example, the power supply unit 20 is mounted on at least one of the main body unit 10 and the mounting unit 30 and fixed. The power supply unit 20 may be not to be fixed to the main body unit 10 and the mounting unit 30.

The mounting unit 30 is a member mounting the chassis 11 on a unit to be mounted (not shown) of the structure or the like.

Hereinafter, the heat transfer member 15 will be described in detail.

The heat transfer member 15 is provided on the heat dissipation member 14. In the case where the heat dissipation member 14 is rectangular, the heat transfer member 15 is disposed on the heat dissipation member 14 along two facing sides of the heat dissipation member 14, and is founded in the direction from the light source 12 toward the cover body 16.

The heat transfer member 15 is, for example, plate-like. In the case where the heat transfer member 15 is plate-like, a shape of an end portion 15t1 on the reflector 13 side of the heat transfer member 15 has a slope viewed from one side surface, and has a circular arc viewed from the other side surface. A shape of an end potion 15t2 on the heat dissipation member 14 of the heat transfer member 15 has a linear line in both cases of viewing from the one side surface and the other side surface. Here, the one side surface is a side surface placed perpendicularly to the other side surface.

The shape of the end portion 15t1 is trapezoidal when projected onto the flat surface perpendicular to the direction from the light source 12 toward the cover body 16. The shape of the end portion 15t2 is rectangular when projected onto the flat surface perpendicular to the direction from the light source 12 toward the cover body 16.

The heat transfer member 15 can be formed of a material having a high thermal conductivity. The heat transfer member 15 can be formed of, for example, a pure metal such as aluminum (Al), copper (Cu) and an alloy. However, it is not limited to these, and can be formed of an inorganic material having high thermal conductivity such as aluminum nitride (AlN), aluminum oxide (Al₂O₃), steatite (MgO.SiO₂), and an organic material such as a high thermal conductivity resin as well.

The heat transfer member 15 can be formed, for example, based on a heat pipe. The heat pipe is a pipe into which volatile liquid is sealed as an operating fluid, the pipe being formed of an alloy of aluminum (Al) or copper (Cu) or the like. The fluid warmed up on a high temperature side is evaporated to move a low temperature side and is condensed. The condensed fluid returns to the high temperature side by a capillary action. The cycle like this causes the heat to move from the high temperature side to the low temperature side.

The heat transfer member 15 is provided on the heat dissipation member 14, for example, by bonding the end portion 15t2 to a portion of the heat dissipation member 14 by a bonding portion 17b. The bonding portion 17b bonding the end portion 15t2 of the heat transfer member 15 to the portion of the heat transfer member 14 is, for example, a bonding agent including a metal material. The bonding portion 17b is a metal bonding agent being heat conductive, for example, an alloy solder of lead (Pb) and tin (Sn). The bonding portion 17a may include a lead free solder or the like containing silver (Ag) and copper (Cu). The end portion 15t1 of the heat transfer member 15 may be bonded to a portion of the reflector 13 based on the bonding portion 17b.

The heat transfer member 15 thermally bonds to the reflector 13 and the heat dissipation member 14. For example, the end portion 15t1 of the heat transfer member 15 contacts the portion of the reflector 13 (for example, a portion of an outer wall surface), and the end portion 15t2 of the heat transfer member 15 contacts the portion of the heat dissipation member 14 via the bonding portion 17b. Thereby, as shown by arrows a2, a3 of FIG. 5, after a portion of the heat generated in the light source 12 is transferred from the heat dissipation member 14 to the heat transfer member 15 by thermal conduction, it is transferred from the heat transfer member 15 to the reflector 13.

For example, a distance between the heat transfer member 15 and the end portion 13t2 of the reflector 13 is shorter than a distance between the heat transfer member 15 and the end portion 13t1 of the reflector 13. If the heat transfer member 15 is provided in this way, the distance between the light source 12 and the heat transfer member 15 can be shortened, and the heat can be easy to be transferred to the heat transfer member 15. This allows heat dissipation from the reflector 13 side to be improved.

Here, the distance between the components means a distance in any coordinate axis between the object components. For example, in the case where the direction from the light source 12 toward the cover body 16 is taken as the Z-axis direction, the distance between the components corresponds to the distance in the Z-axis direction. The distance between the components corresponds to the distance in the direction perpendicular to the direction from the light source 12 toward the cover body 16 (namely, X-axis direction or Y-axis direction).

As described previously, the heat transfer member 15 is disposed on the heat dissipation member 14 along the two facing sides of the heat dissipation member 14, and is found in the direction from the light source 12 toward the cover body 16. The heat transfer member 15 is plate-like, and thermally bonds to the reflector 13 and the heat dissipation member 14.

As described above, if the heat transfer member 15 is provided on the illumination device 1, after the portion of the heat generated in the light source 12 is transferred from the heat dissipation member 14 to the heat transfer member 15 by thermal conduction, it is transferred from the heat transfer member 15 to the reflector 13. This allows heat dissipation from the reflector 13 side to be improved.

The heat transfer member 15 can have various dispositions and shapes causing the heat to dissipate by transferring the heat to the reflector without limiting to dispositions and shapes described previously.

Hereinafter, another form will be shown about disposition and shape of the heat transfer member 15.

FIG. 6 shows another form of the portion of the illuminating device according to the embodiment.

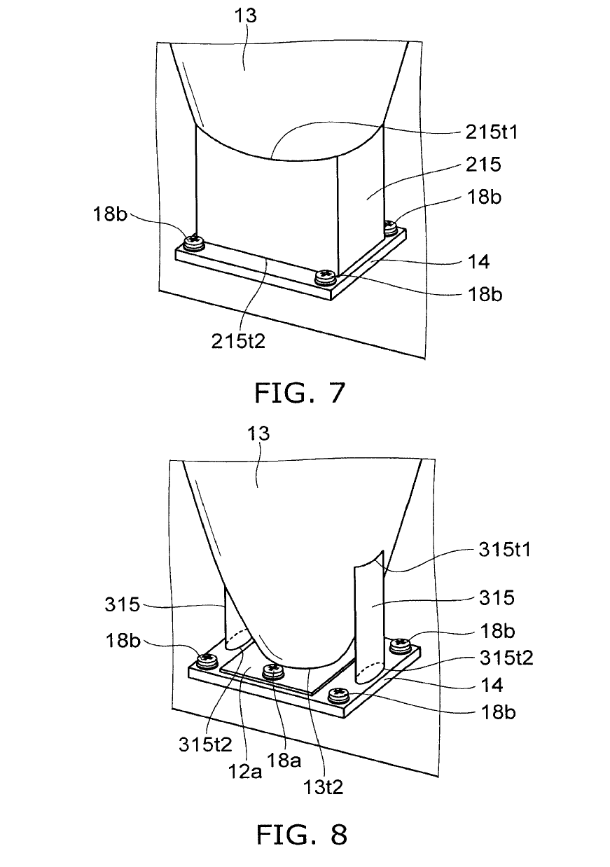

FIG. 7 shows another form of the portion of the illuminating device according to the embodiment.

FIG. 8 shows another form of the portion of the illuminating device according to the embodiment.

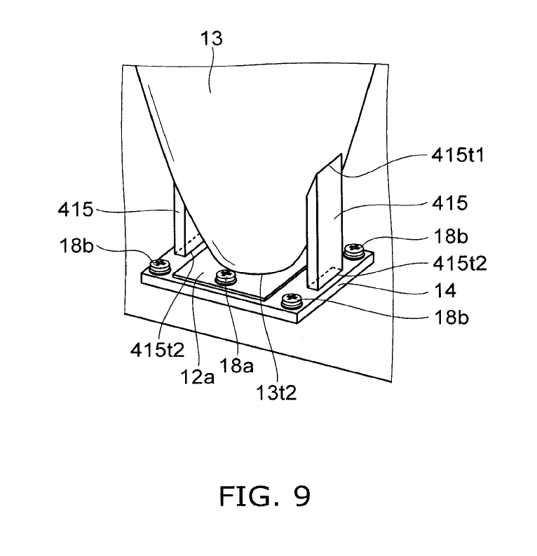

FIG. 9 shows another form of the portion of the illuminating device according to the embodiment.

All of FIG. 6 to FIG. 9 are enlarged views of the members disposed in the proximity of the light source as shown in FIG. 4.

As shown in FIG. 6, in the case where the heat dissipation member 14 is rectangular, a heat transfer member 115 is disposed on the heat transfer member 14 along four sides of the heat dissipation member 14, and is found in the direction from the light source 12 toward the cover body 16. The heat transfer member 115 is provided so as to contact the portion of the reflector 13 on an end portion 115t1 and to contact the portion of the heat dissipation member 14 on an end portion 115t2 via the bonding portion 17b. The heat transfer member 115 is plate-like.

If the heat transfer member 115 is disposed on the heat dissipation member 14 along four sides of the heat dissipation member 14 like the embodiment, a contact area between the end portion 115t1 of the heat transfer member 115 and the reflector 13 and a contact area between the end portion 115t2 of the heat transfer member 115 and the heat dissipation member 14 can be increased. A thermally bonding ratio between the end portion 115t1 of the heat transfer member 115 and a thermally bonding ratio between the end portion 115t2 of the heat transfer member 115 and the heat dissipation member 14 are increased. Thereby, the portion of the heat generated in the light source 12 becomes easy to be transferred from the heat dissipation member 14 to the reflector 13 via the heat transfer member 115 by thermal conduction.

The heat transfer member 115 may be disposed on the heat dissipation member 14 along 1 side or 3 sides of the heat dissipation member 14. That is, the heat transfer member 115 is only necessary to be disposed on the heat dissipation member 14 along at least 1 side of the heat dissipation member 14. The heat transfer member 115 may not be disposed along the side of the heat dissipation member 14. For example, at least one heat transfer member 115 can be disposed between a periphery of the substrate 12a and a periphery of the heat dissipation member 14.

As shown in FIG. 7, in the case where the heat dissipation member 14 is rectangular, a heat transfer member 215 is disposed on the heat dissipation member 14 along the whole circumference of the heat dissipation member 14, and is provided so as to surround the portion of the reflector 13. The heat transfer member 215 is provided so as to contact the portion of the reflector 13 on an end portion 215t1, and to contact the portion of the heat dissipation member 14 on an end portion 215t2 via the bonding portion 17b.

The heat transfer member 215 is, for example, ring-shaped. The portion of the reflector 13 is provided in a ring-shaped opening. The end portion 215t1 of the heat transfer member 215 is ring-shaped when projected onto the flat surface perpendicular to the direction from the light source 12 toward the cover body 16. The end portion 215t2 of the heat transfer member 215 is square annular when projected onto the flat surface perpendicular to the direction from the light source 12 toward the cover body 16.

The heat transfer member 215 is disposed on the heat dissipation member 14 along the whole circumference of the heat dissipation member 14 so as to surround the portion of the reflector, a contact area between the end portion 215t1 of the heat transfer member 215 and the reflector 13 and a contact area between the end portion 215t2 of the heat transfer member 215 and the heat dissipation member 14 can be increased. A thermally bonding ratio between the end portion 215t1 of the heat transfer member 215 and a thermally bonding ratio between the end portion 215t2 of the heat transfer member 215 and the heat dissipation member 14 are increased. Thereby, the portion of the heat generated in the light source 12 becomes easy to be transferred from the heat dissipation member 14 to the reflector 13 via the heat transfer member 215 by thermal conduction.

The shape of the heat transfer member 15 is not limited to the shapes previously described, and the heat transfer member 15 can be formed based on various shapes. For example, as shown in FIG. 8, a heat transfer member 315 can be columnar. In such a case, for example, the heat transfer member 315 is disposed on the heat dissipation member 14 along facing two sides of the rectangular heat dissipation member, and is found in the direction from the light source 12 toward the cover body 16. The heat transfer member 315 is provided so as to contact the portion of the reflector 13 on an end portion 315t1, and to contact the portion of the heat dissipation member 14 on an end portion 314t2 via the bonding portion 17b.

As shown in FIG. 9, a heat transfer member 415 may be square columnar. In such a case, for example, the heat transfer member 415 is disposed on the heat dissipation member 14 along facing two sides of the rectangular heat dissipation member 14, and is found in the direction from the light source 12 toward the cover body 16. The heat transfer member 415 is provided so as to contact the portion of the reflector 13 on an end portion 414t1, and to contact the portion of the heat dissipation member 14 on an end portion 415t2 vis the bonding portion 17b. The heat transfer member 415 may be polygonal prism-shaped other than square columnar.

Various forms about disposition and shape or the like of the heat transfer member 15 are shown in FIG. 6 to FIG. 9. Another way is that the heat transfer member 15 can be provided so as to gradually decrease a width of the heat transfer member 15 in the direction perpendicular to the direction from the light source 12 toward the cover body 16 with approaching from the heat dissipation member 14 toward the reflector 13.

In the illuminating device 1 of the embodiment, the heat transfer member 15 is provided so as to thermally bond to the reflector 13. If the heat transfer member 15 is provided on the illumination device 1 like this, the heat dissipation from the reflector 13 side can be improved. This allows the heat dissipation of the illuminating device 1 to be improved.

Hereinafter, original analysis results from which the conditions described above are derived will be described.

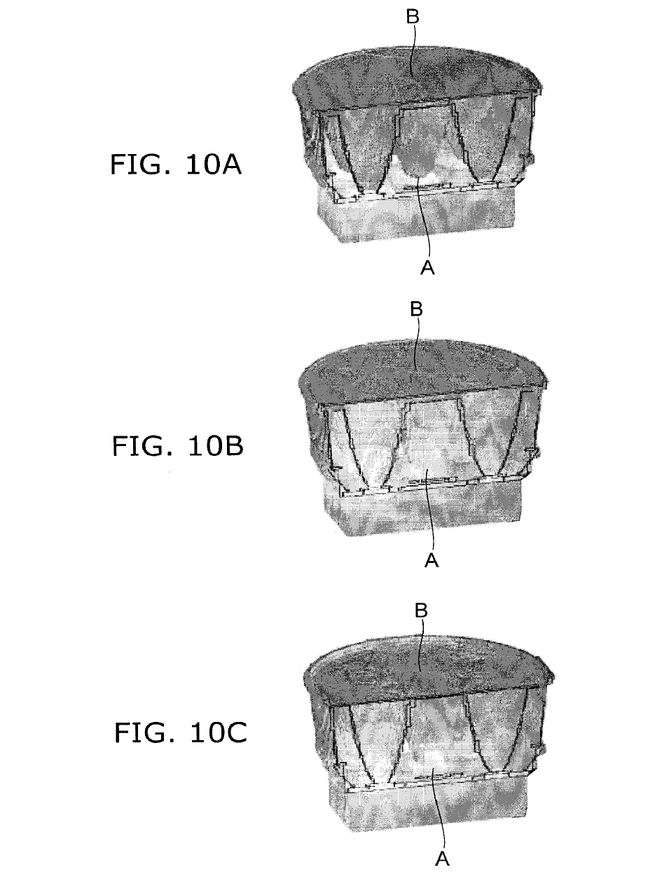

FIG. 10A to FIG. 10C shows heat dissipation of the illuminating device.

All of FIG. 10A to FIG. 10C show a temperature contour of the analysis results of a thermal fluid. FIG. 10A to FIG. 10C shows a temperature distribution of the main body unit of the illumination device.

FIG. 10A to FIG. 10C shows the temperature distribution inside the main body unit, and the inside corresponds to the inside of the main body unit of FIG. 3. The temperature distribution is indicated by an intensity of monotone color, and the indication is pale for a higher temperature and dark for a lower temperature. A position point A in FIG. 10A to FIG. 10C indicates a point or a region where the light source 12 is placed. A position point B in FIG. 10A to FIG. 10C indicates a point or a region where the cover body 16 is placed. The temperature is in a range from 25 degrees to 100 degrees.

Hereinafter, the configuration of the main body unit of the illuminating device in FIG. 10A to FIG. 10C will be described.

In FIG. 10A to FIG. 10C, the main body unit 10 includes the chassis 11, the light source 12, the reflector 13, the heat dissipation member 14, and the cover body 16. The number of the light source 12 and the reflector 13 is 7, respectively.

In FIG. 10A, the heat transfer member 15 is not provided in the main body unit 10. In FIG. 10B and FIG. 10C, the heat transfer member 15 is provided between the reflector 13 and the heat dissipation member 14 so as to correspond to each of the light sources 12. Specifically, as shown in FIG. 3 and FIG. 4, the heat transfer member 15 is disposed on the heat dissipation member 14 along facing two sides of the heat dissipating member 14, and is found in the direction from the light source 12 toward the cover body 16. The heat transfer member 15 is provided so as to contact the portion of the reflector 13 on the end portion 15t1 and to contact the portion on the heat dissipation member 14 on the end portion 15t2 via the bonding portion 17b.

In FIG. 10B, the cover body 16 does not contact the reflector 13 (end portion 13t1). In FIG. 10C, the cover body 16 contacts the reflector 13 (end portion 13t1).

That is, the main body unit of the illuminating device in FIG. 10A is the main body unit of the illuminating device of a reference example, and the main body unit of the illuminating device in FIG. 10B and FIG. 10C is the main body unit of the illuminating device 1 of the embodiment.

Compared the temperature distribution in FIG. 10A with the temperature distribution in FIG. 10B, the temperature at the position point A is high in FIG. 10A. That is, the temperature near the light source 12 in FIG. 10A is high. The temperature at the position point A in FIG. 10A is 88.6 degrees, and the temperature at the position point A in FIG. 10B is 87.5 degrees.

Compared the temperature distribution in FIG. 10A with the temperature distribution in FIG. 10B, the temperature at the position point B is high in FIG. 10B. That is, the temperature near the cover body 16 in FIG. 10B is high. The temperature at the position point B in FIG. 10A is 44.0 degrees, and the temperature at the position point B in FIG. 10B is 50.0 degrees.

In the case where the heat transfer member 15 is provided so as to thermally bond to the reflector 13 from the temperature distribution in FIG. 10A and FIG. 10B, in comparison with the case of not providing the heat transfer member 15, the temperature near the cover body 16 can be increased by decreasing the temperature near the light source 12. If the heat transfer member 15 is provided, the temperature near the light source 12 is reduced by approximately 1 degree.

It has been found that the heat transfer path from the light source 12 to the reflector 13 is formed by providing the heat transfer member 15 and the heat dissipation from the reflector 13 side is improved. Specifically, it has been found that a ratio of the heat transfer from the light source 12 to the reflector 13 increases by approximately 4%. Thereby, it has been found that the heat dissipation of the illuminating device 1 is improved.

Compared the temperature distribution in FIG. 10A with the temperature distribution in FIG. 10B, the temperature ar the position point A is high in FIG. 10A. That is, the temperature near the light source 12 in FIG. 10A is high. Compared the temperature distribution in FIG. 10B with the temperature distribution in FIG. 10C, the temperature at the position point A is high in FIG. 10B. That is, the temperature near the light source 12 in FIG. 10B is high. The temperature at the position point A in FIG. 10C is 86.6 degrees.

Compared the temperature distribution in FIG. 10A with the temperature distribution in FIG. 10C, the temperature at the position point B is high in FIG. 10C. That is, the temperature near the cover body 16 in FIG. 10C is high. Compared the temperature distribution in FIG. 10B with the temperature distribution in FIG. 10C, the temperature at the position point B is high in FIG. 10C. That is, the temperature near the cover body 16 in FIG. 10C is high. The temperature at the position point B in FIG. 10C is 65.0 degrees.

In the case where the heat transfer member 15 is provided so as to thermally bond to the light source 12 and the reflector 13 from the temperature distribution in FIG. 10A and FIG. 10C, in comparison with the case of not providing the heat transfer member 15, the temperature near the cover body 16 can be increased by decreasing the temperature near the light source 12. In the case where the cover body 16 is contacted with the reflector 13 from the temperature distribution in FIG. 1B and FIG. 10C, in comparison with the case of not causing the cover body 16 to contact the reflector 13, the temperature near the cover body 16 can be increased by decreasing the temperature near the light source 12. If the heat transfer member 15 is provided in the state of contacting the cover body 16 and the reflector 13, the temperature near the light source 12 is reduced by approximately 2 degrees.

It has been found that the heat transfer path from the light source 12 to the reflector 13 is formed by providing the heat transfer member 15 and the heat dissipation from the reflector 13 side is improved. Specifically, it has been found that a ratio of the heat transfer from the light source 12 to the reflector 13 increases by approximately 4%. It has been found that if the cover body 16 is caused to contact the reflector 13, the heat transferred from the light source 12 to the reflector 13 via the heat transfer member 15 becomes easy to be emitted from the cover body 16. Thereby, it has been found that the heat dissipation of the illuminating device 1 is improved.

Hereinafter, the heat dissipation in the illuminating device 1 of the embodiment will be described.

Most of the heat generated in the light source 12 is transferred to the multiple heat dissipation fins 11c via the heat dissipation member 14 by thermal conduction, and emitted externally from the multiple heat dissipation fins 11c. A portion of the heat generated in the light source 12 is transferred to the bottom face portion 11a and the side wall portion 112b by radiation and convection, and emitted externally from the bottom face portion 11a and the side wall portion 11b.

A portion of the heat generated in the light source 12 is transferred to the heat transfer member 15 via the heat dissipation member 14 by thermal conduction. After that, the heat transferred to the heat transfer member 15 is transferred to the reflector 13 by thermal conduction and emitted externally from the reflector 13. In the case where the cover body 16 contacts the reflector 13, the heat transferred to the heat transfer member 15 is emitted externally from the reflector 13 and transferred from the reflector 13 to the cover body 16 by thermal conduction to be externally emitted from the cover body 16.

Here, by ordinary, light output of the illuminating device is increased by increasing the number of the light sources per unit area and increasing a current flowing through the respective light sources. This results in increase of a heat generation density of the light source and increase of a thermal resistance accompanying with heat spread near the light source. The increase of the thermal resistance increases the temperature in the illuminating device (for example, in the main body unit). The temperature increase in the illuminating device leads to life shortening and light flux decrease of the light emitting element or the like.

In the illuminating device 1 of the embodiment, the heat transfer member 15 is provided to thermally bond to the reflector 13. If the heat transfer member 15 is provided in the illuminating device 1 like this, the heat dissipation from the reflector 13 side can be improved. This allows the heat dissipation of the illuminating device 1 to be improved.

If the heat transfer member 15 is provided in the illuminating device 1 like this, the thermal resistance can be reduced without changing the size of the illuminating device 1. This allows the life shortening and the light flux decrease of the light emitting element or the like due to the temperature increase to be suppressed, and the illuminating device with high performance to be provided.

According to the embodiment, the illuminating device with the high performance capable of increasing the heat dissipation is provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An illuminating device comprising:
a light source including a light emitting element;
a reflector provided to surround the light source; and
a heat transfer member provided outside the reflector and thermally bonded to the reflector.

2. The device according to claim 1, wherein
the reflector is tubular, and is opened on both ends of the reflector,
the light source is provided in an opening formed on one end portion of the reflector, and
the heat transfer member contacts a side surface of the reflector.

3. The device according to claim 2, wherein
a distance between the heat transfer member and the one end portion of the reflector is shorter than a distance between the heat transfer member and one other end portion of the reflector.

4. The device according to claim 3, further comprising:
a cover body covering an opening formed on the one other end portion of the reflector and contacting the one other end portion of the reflector.

5. The device according to claim 1, further comprising:
a heat dissipation member thermally bonded to the heat transfer member, the heat dissipation member being generally rectangular,
the heat transfer member being provided along at least one side of the heat dissipation member.

6. The device according to claim 5, wherein
the heat transfer member is plate-like,
the heat transfer member is provided on the heat dissipation member along facing two sides of the heat dissipation member,
one end of the heat transfer member contacts a side surface of the reflector, and
one other end of the heat transfer member contacts the heat dissipation member via a bonding portion.

7. The device according to claim 5, wherein
the heat transfer member is plate-like,
the heat transfer member is provided on the heat dissipation member along four sides of the heat dissipation member,
one end of the heat transfer member contacts a side surface of the reflector, and
one other end of the heat transfer member contacts the heat dissipation member via a bonding portion.

8. The device according to claim 5, wherein
the heat transfer member is annular,
the heat transfer member is provided on the heat dissipation member along the whole circumference of the heat dissipation member,
one end of the heat transfer member contacts a side surface of the reflector, and
one other end of the heat transfer member contacts the heat dissipation member via a bonding portion.

9. The device according to claim 8, wherein
a portion of the reflector is provided in the heat transfer member.

10. The device according to claim 5, wherein
the heat transfer member is polygonal prism-shaped or columnar,
the heat transfer member is provided on the heat dissipation member along facing two sides of the heat dissipation member,
one end of the heat transfer member contacts a side surface of the reflector, and
one other end of the heat transfer member contacts the heat dissipation member via a bonding portion.

11. An illumination device comprising:
a main body unit including a light source including a light emitting element, a reflector provided to surround the light source, a heat transfer member provided outside the reflector and thermally bonded to the reflector, and a chassis housing the light source, the reflector and the heat transfer member; and
a power supply unit supplying power to the light source.

12. The device according to claim 11, wherein
the main body unit includes a first heat dissipation portion thermally bonded to the heat transfer member, the first heat dissipation portion being generally rectangular,
the chassis includes a bottom face portion having a first surface and a second surface being an opposite surface to the first surface, a side wall portion provided on a periphery of the first surface, and a second heat dissipation portion provided on the second surface,
the light source, the reflector, the heat transfer member and the first heat dissipation portion are provided in a region surrounded by the first surface and the side wall portion,
the reflector is tubular, and is opened on both ends of the reflector,
the light source is provided in an opening formed on one end portion of the reflector, and
the heat transfer member contacts a side surface of the reflector.

13. The device according to claim 12, wherein
a distance between the heat transfer member and the one end portion of the reflector is shorter than a distance between the heat transfer member and one other end portion of the reflector.

14. The device according to claim 13, further comprising:
a cover body covering an opening formed on the one other end portion of the reflector and contacting the one other end portion of the reflector.

15. The device according to claim 12, wherein
the heat transfer member is plate-like,
the heat transfer member is provided on the first heat dissipation portion along facing two sides of the first heat dissipation portion,
one end of the heat transfer member contacts a side surface of the reflector, and
one other end of the first heat transfer unit contacts the first heat dissipation portion via a bonding portion.

16. The device according to claim 12, wherein
the heat transfer member is plate-like,
the heat transfer member is provided on the first heat dissipation portion along four sides of the first heat dissipation portion
one end of the heat transfer member contacts a side surface of the reflector, and
one other end of the heat transfer member contacts the first heat dissipation portion via a bonding portion.

17. The device according to claim 12, wherein
the heat transfer member is annular,
the heat transfer member is provided on the first heat dissipation portion along the whole circumference of the heat dissipation portion,
one end of the heat transfer member contacts a side surface of the reflector, and
one other end of the heat transfer member contacts the first heat dissipation portion via a bonding portion.

18. The device according to claim 17, wherein
a portion of the reflector is provided in the heat transfer member.

19. The device according to claim 12, wherein
the heat transfer member is polygonal prism-shaped or columnar,
the heat transfer member is provided on the first heat dissipation portion along facing two sides of the first heat dissipation portion,
one end of the heat transfer member contacts a side surface of the reflector, and
one other end of the heat transfer member contacts the first heat dissipation portion via a bonding portion.

20. The device according to claim 11, wherein
The heat transfer member includes at least one of aluminum and copper.
